(19) United States
(12) Patent Application Publication
(10) Pub. No.: US 2025/0319398 A1
(43) Pub. Date: Oct. 16, 2025

(54) EDITING GAME SCENE IMAGES

(71) Applicant: Tencent Technology (Shenzhen) Company Limited, Shenzhen (CN)

(72) Inventors: Chenghao Ye, Shenzhen (CN); Ziyi Wang, Shenzhen (CN)

(21) Appl. No.: 19/037,376

(22) Filed: Jan. 27, 2025

Related U.S. Application Data
(63) Continuation of application No. PCT/CN2023/129588, filed on Nov. 3, 2023.

(30) Foreign Application Priority Data
Jan. 6, 2023 (CN) 202310019753.6

(51) Int. Cl. A63F 13/525; A63F 13/60

(52) U.S. Cl. CPC A63F 13/525; A63F 13/60

(57) ABSTRACT

This application provides a method and apparatus for editing a game scene image. The method includes: loading, in response to an editing instruction for the game scene image, game scene data of the game scene image to restore a game scene of the game scene image, the game scene image being obtained by photographing the game scene in a game ongoing process; adjusting, in response to an adjusting operation for game elements in the game scene, the game elements in the game scene and displaying an adjusted game scene; and updating, in response to an image saving instruction, the game scene image based on the adjusted game scene. This application realizes a solution for delayed editing of a game scene image without interrupting an ongoing game. Normal proceeding of a game and/or the display effect of the game scene image are improved.

### CROSS-REFERENCE TO RELATED APPLICATIONS

This application is a continuation application of PCT Application PCT/CN2023/129588, filed Nov. 3, 2023, which claims priority to Chinese Patent Application No. 202310019753.6, filed on Jan. 6, 2023, each entitled “METHOD AND APPARATUS FOR EDITING GAME SCENE IMAGE, COMPUTER DEVICE, AND STORAGE MEDIUM”, and each which is incorporated herein by reference in its entirety.

### FIELD

Aspects described herein relate to the field of computer technologies, and in particular, to a method and apparatus for editing a game scene image.

### BACKGROUND

With the development of computer technologies, there are increasing types of electronic games. In some electronic games, a currently displayed game scene can be photographed in a game ongoing process to obtain a game scene image. Usually, in order to guarantee the display effect of the photographed game scene image, prior to photographing, it is needed to adjust game elements in the game scene, and then a photographing instruction is triggered to photograph an adjusted game scene to obtain the game scene image.

### SUMMARY

Aspects described herein provide a method and apparatus for editing a game scene image, a computer device, and a storage medium. The technical solutions are as follows:

In one aspect, a method for editing a game scene image is provided. The method includes:
loading, in response to an editing instruction for the game scene image, game scene data of the game scene image to restore a game scene of the game scene image, the game scene image being obtained by photographing the game scene in a game ongoing process;
adjusting, in response to an adjusting operation for game elements in the game scene, the game elements in the game scene and displaying an adjusted game scene; and
updating, in response to an image saving instruction, the game scene image based on the adjusted game scene.

In another aspect, a method for editing a game scene image is provided. The method includes:
receiving a data acquisition request sent by a terminal, the data acquisition request carrying an identification code of the game scene image and the data acquisition request being sent by the terminal in response to an editing instruction for the game scene image;
querying, based on the data acquisition request, the game scene data stored corresponding to the identification code and sending the game scene data to the terminal,
where the terminal is configured to receive the game scene data and load the game scene data to restore a game scene of the game scene image; adjust, in response to an adjusting operation for game elements in the game scene, the game elements in the game scene and displaying an adjusted game scene; and update, in response to an image saving instruction, the game scene image based on the adjusted game scene.

In another aspect, an apparatus for editing a game scene image is provided. The apparatus includes:
a restoring module, configured to load, in response to an editing instruction for the game scene image, game scene data of the game scene image to restore a game scene of the game scene image, the game scene image being obtained by photographing the game scene in a game ongoing process;
an adjusting module, configured to adjust, in response to an adjusting operation for game elements in the game scene, the game elements in the game scene and display an adjusted game scene; and
an updating module, configured to update, in response to an image saving instruction, the game scene image based on an adjusted game scene.

In another aspect, an apparatus for editing a game scene image is provided. The apparatus includes:
a receiving module, configured to receive a data acquisition request sent by a terminal, the data acquisition request carrying an identification code of the game scene image and the data acquisition request being sent by the terminal in response to an editing instruction for the game scene image; and
a transmission module, configured to query the game scene data stored corresponding to the identification code based on the data acquisition request and send the game scene data to the terminal,
where the terminal is configured to receive the game scene data and load the game scene data to restore a game scene of the game scene image; adjust, in response to an adjusting operation for game elements in the game scene, the game elements in the game scene and displaying an adjusted game scene; and update, in response to an image saving instruction, the game scene image based on the adjusted game scene.

In another aspect, a computer device is provided. The computer device includes a processor and a memory, the memory having at least one computer program stored therein, the at least one computer program being loaded and executed by the processor, to implement the operations of the method for editing a game scene image described in the above aspects.

In another aspect, a computer-readable storage medium is provided. The computer-readable storage medium has at least one computer program stored therein, the at least one computer program being loaded and executed by a processor, to implement the operations of the method for editing a game scene image described in the above aspects.

In yet another aspect, a computer program product is provided. The computer program product includes a computer program, the computer program, when executed by a processor, implementing the operations of the method for editing a game scene image described in the above aspects.

In the solutions provided by the examples of this application, in a game running process, after the game scene is photographed to obtain the game scene image, the game scene image can also be edited. When the game scene image is edited, even at the end of the game, the game scene when the game scene image is photographed can also be restored, so that the game elements in the game scene are adjusted conveniently, and the content included in the displayed game scene is adjusted. Then the content included in the adjusted game scene changes. Furthermore, based on the adjusted game scene, the game scene image is updated, so that the content included in the updated game scene image is the same as the content included in the adjusted game scene. This image editing mode edits the substantial content included in the game scene image to realize a solution for delayed editing of the game scene image, which not only guarantees that in the game ongoing process, the game scene image can be timely photographed, without interrupting the ongoing game, guaranteeing normal proceeding of the game, but also can guarantee the display effect of the obtained game scene image, so that the user experience is further improved.

### BRIEF DESCRIPTION OF THE DRAWINGS

FIG. 1 is a schematic structural diagram of an implementation environment provided by one or more illustrative aspects described herein.

FIG. 2 is a flowchart of a method for editing a game scene image provided by one or more illustrative aspects described herein.

FIG. 3 is a flowchart of another method for editing a game scene image provided by one or more illustrative aspects described herein.

FIG. 4 is a flowchart of another method for editing a game scene image provided by one or more illustrative aspects described herein.

FIG. 5 is a flowchart of another method for editing a game scene image provided by one or more illustrative aspects described herein.

FIG. 6 is a flowchart of another method for editing a game scene image provided by one or more illustrative aspects described herein.

FIG. 7 is a schematic diagram of displaying a restored game scene by a terminal provided by one or more illustrative aspects described herein.

FIG. 8 is a schematic diagram of adjusting a virtual camera provided by one or more illustrative aspects described herein.

FIG. 9 is a schematic flowchart of comparing image editing solutions provided by one or more illustrative aspects described herein.

FIG. 10 is another schematic diagram of displaying a restored game scene by one or more illustrative aspects described herein.

FIG. 11 is a schematic diagram of position adjustment provided by one or more illustrative aspects described herein.

FIG. 12 is a schematic diagram of posture adjustment provided by one or more illustrative aspects described herein.

FIG. 13 is a flowchart of another method for editing a game scene image provided by one or more illustrative aspects described herein.

FIG. 14 is a flowchart of another method for editing a game scene image provided by one or more illustrative aspects described herein.

FIG. 15 is a flowchart of another method for editing a game scene image provided by one or more illustrative aspects described herein.

FIG. 16 is a flowchart of another method for editing a game scene image provided by one or more illustrative aspects described herein.

FIG. 17 is another schematic diagram of comparing image editing solutions provided by one or more illustrative aspects described herein.

FIG. 18 is another schematic diagram of comparing image editing solutions provided by one or more illustrative aspects described herein.

FIG. 19 is a schematic structural diagram of an apparatus for editing a game scene image provided by one or more illustrative aspects described herein.

FIG. 20 is another schematic structural diagram of an apparatus for editing a game scene image provided by one or more illustrative aspects described herein.

FIG. 21 is another schematic structural diagram of an apparatus for editing a game scene image provided by one or more illustrative aspects described herein.

FIG. 22 is another schematic structural diagram of an apparatus for editing a game scene image provided by one or more illustrative aspects described herein.

FIG. 23 is a schematic structural diagram of a terminal provided by one or more illustrative aspects described herein.

FIG. 24 is a schematic structural diagram of a server provided by one or more illustrative aspects described herein.

### DESCRIPTION OF EMBODIMENTS

To make objectives, technical solutions, and advantages of examples and aspects of this application clearer, implementations of this application are described below in further detail with reference to drawings. The words “examples” and “aspects” may be used interchangeably throughout.

The terms “first”, “second”, and the like used herein may be used for describing various concepts in this specification. However, the concepts are not limited by the terms unless otherwise specified. The terms are merely used for distinguishing one concept from another concept. For example, without departing from the scope of this application, a first virtual object may be referred to as a second virtual object, and similarly, the second virtual object may be referred to as the first virtual object.

In terms “at least one”, “a plurality of”, “each”, and “any one” used in this application, “at least one” includes one, two, or more, “a plurality of” include two or more, “each” refers to each of a plurality of corresponding items, and “any one” refers to any one of a plurality of items. For example, a plurality of game scene images include three game scene images and each refers to each game scene image in the three game scene images. Any one refers to any one of the three game scene images, and may be the first game scene image, or the second game scene image, or the third game scene image.

The game scene image, the game scene data, and the like involved in this application are all authorized by the user or fully authorized by all parties, and the collection, use, and processing of relevant data shall comply with relevant laws, regulations, and standards of relevant countries and regions. For example, the game scene image, the game scene data, and the like involved in this application are obtained under full authorization.

A method for editing a game scene image provided by the examples of this application is executed by a computer device. In one embodiment, the computer device may be a terminal or a server. In one embodiment, the server is an independent physical server, a server cluster composed of a plurality of physical servers or a distributed system, or a cloud server that provides basic cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence (AI) platform. In one embodiment, the terminal is a smart phone, a tablet computer, a notebook computer, a desktop computer, a smart speaker, a smart watch, a smart voice interaction device, a smart household appliance, an on-board terminal, or the like, which is not limited thereto. In one embodiment, the method is executed through the interaction between the server and the terminal.

In some examples, the computer program involved in the examples of this application may be deployed in one computer device for execution, or deployed in a plurality of computer devices at one location for execution, or distributed in a plurality of computer devices at a plurality of locations and connected via a communication network. The plurality of computer devices at the plurality of locations and connected via the communication network may form a blockchain system.

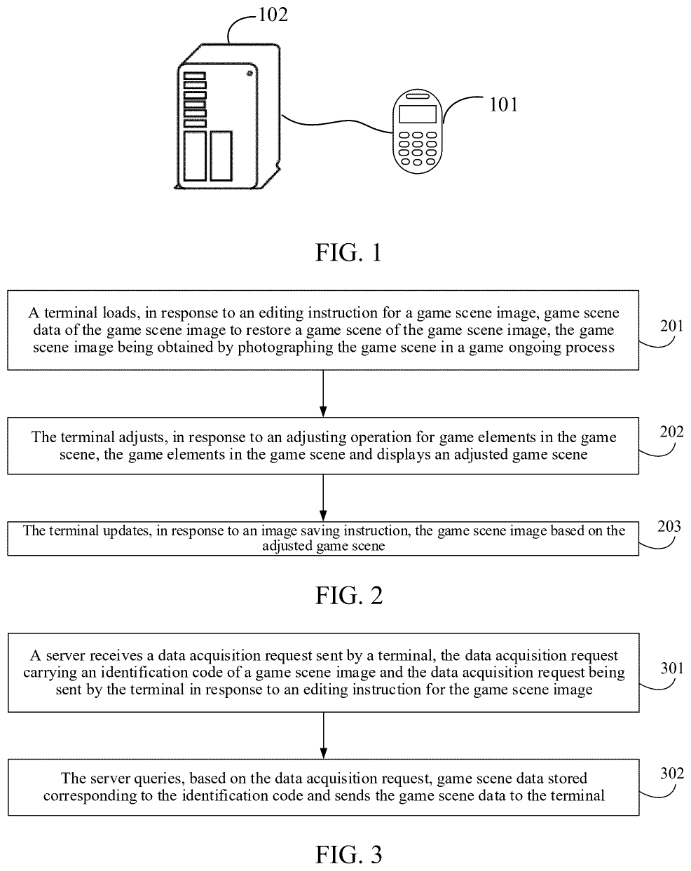

In some examples, the computer device is a terminal. FIG. 1 is a schematic diagram of an implementation environment provided by an example of this application. As shown in FIG. 1, the implementation environment includes a terminal 101 and a server 102. The terminal 101 and the server 102 are connected to each other by a wired or wireless network.

The server 102 is configured to provide a game service to the terminal 101. The terminal 101 is interacted with the server 102 and thus can acquire game scene data of a game from the server 102 to render a game scene based on the scene data to realize running of the game. Moreover, the terminal 101 can photograph the game scene in the game running process to obtain a game scene image and can edit the game scene image.

In a possible implementation, a target application provided with a service by the server 102 is installed in the terminal 101, and the terminal 101 can realize, for example, functions such as gaming and message interaction through the target application. In one embodiment, the target application is a target application in an operating system of the terminal 101 or a target application provided by a third party. For example, the target application is a game application. The game application has a gaming function. Of course, the game application may also have other functions, for example, a shopping function, a navigation function, and the like.

In some electronic games, a currently displayed game scene can be photographed in a game ongoing process to obtain a game scene image. Usually, in order to guarantee the display effect of the photographed game scene image, prior to photographing, it is needed to adjust game elements in the game scene, and then a photographing instruction is triggered to photograph an adjusted game scene to obtain the game scene image. However, it is needed to interrupt the ongoing game to adjust the game scene, which affects normal proceeding of the game. Therefore, the example of this application provides a solution for delayed editing of the game scene image, which not only guarantees that in the game ongoing process, the game scene image can be timely photographed, without interrupting the ongoing game, guaranteeing normal proceeding of the game, but also can guarantee the display effect of the obtained game scene image.

FIG. 2 is a flowchart of a method for editing a game scene image provided by an example of this application. Taking the method being executed by a terminal as an example, as shown in FIG. 2, the method includes:

201. A terminal loads, in response to an editing instruction for a game scene image, game scene data of the game scene image to restore a game scene of the game scene image, the game scene image being obtained by photographing the game scene in a game ongoing process.

The content included in the game scene is displayed in the game scene image. For example, if the game scene image is a game photo, and the game photo is obtained by photographing the displayed game scene in the game ongoing process, then the content included in the game photo is the content included in the displayed game scene during photographing. The game scene data is configured to render the game scene. The game scene data of the game scene image indicates the game scene displayed when the game scene image is photographed in the game running process. That is, the game scene data is configured to render the game scene displayed when the game scene image is photographed. The game scene refers to a virtual scene where the game proceeds. For example, competitions can be held or tasks can be completed in this virtual scene in the virtual scene. The game is a game of any type. For example, the game is a 2 Dimensional (2D) game or a 3 Dimensional (3D) game, or a multiplayer online game.

Loading the game scene data of the game scene image to restore the game scene of the game scene image refers to loading the game scene data to render the game scene to enable the terminal to display the game scene, i.e., reproduce the game scene when the game scene image is photographed.

In the example of this application, in a game running process, after the game scene is photographed to obtain the game scene image, the game scene image can also be edited. When the game scene image is edited, even at the end of the game, the game scene when the game scene image is photographed can also be restored, so that game elements in the game scene are edited to further obtain the updated game scene image, rather than merely performing editing operations such as coloring and scaling the game scene image itself.

202. The terminal adjusts, in response to an adjusting operation for game elements in the game scene, the game elements in the game scene and displays an adjusted game scene.

The game elements are elements included in the game scene. For example, the game elements are virtual objects, virtual bodies, virtual cameras for photographing the game scene, or other game elements in the game scene.

In the example of this application, in a case that the game scene of the game scene image is restored, the game elements in the game scene can be adjusted to adjust the content included in the currently displayed game scene, so that the content included in the adjusted game scene changes. For example, in a case that the game scene of the game scene image is restored, the game scene includes three virtual animals. The three virtual animals face forward. By adjusting the photographing viewing angle and position of the virtual camera in the game scene, the three virtual animals in the adjusted game scene all face backward, i.e., the content included the adjusted game scene changes.

203. The terminal updates, in response to an image saving instruction, the game scene image based on the adjusted game scene.

In the example of this application, the image saving instruction indicates to generate a new game scene image based on a currently displayed game scene to update the previous game scene image. After adjusting the displayed game scene, in response to the image saving instruction, based on the currently displayed game scene, i.e., the adjusted game scene, the new game scene image is generated. The content included in the new game scene image is the content included in the adjusted game scene. Updating the previous game scene image based on the new game scene image refers to replacing the previous game scene image with the new game scene image to complete the process of editing the previous game scene image.

In the solutions provided by the examples of this application, in a game running process, after the game scene is photographed to obtain the game scene image, the game scene image can also be edited. When the game scene image is edited, even at the end of the game, the game scene when the game scene image is photographed can also be restored, so that the game elements in the game scene are adjusted conveniently, and the content included in the displayed game scene is adjusted. Then the content included in the adjusted game scene changes. Furthermore, based on the adjusted game scene, the game scene image is updated, so that the content included in the updated game scene image is the same as the content included in the adjusted game scene. This image editing mode edits the substantial content included in the game scene image to realize a solution for delayed editing of the game scene image, which not only guarantees that in the game ongoing process, the game scene image can be timely photographed, without interrupting the ongoing game, guaranteeing normal proceeding of the game, but also can guarantee the display effect of the obtained game scene image, so that the user experience is further improved.

FIG. 3 is a flowchart of another method for editing a game scene image provided by an example of this application. Taking the method being executed by a server as an example, as shown in FIG. 3, the method includes:

301. A server receives a data acquisition request sent by a terminal, the data acquisition request carrying an identification code of a game scene image and the data acquisition request being sent by the terminal in response to an editing instruction for the game scene image.

In the example of this application, the server has game scene data stored therein. When the terminal photographs a game scene in a game running process to obtain the game scene image, the server stores the game scene data of the game scene image, i.e., stores the game scene data of the game scene displayed when the terminal photographs the game scene image. Therefore, in response to the editing instruction for the game scene image, the terminal sends the data acquisition request to the server to request the game scene data of the game scene image.

The identification code has uniqueness and can be represented by any character. For example, the identification code is represented in the form of a character string. In the example of this application, the server correspondingly stores the identification code and the game scene data, and the terminal also correspondingly stores the identification code and the game scene image. The game scene data and the game scene image stored corresponding to the same identification code in the server and the terminal correspond to each other, i.e., the game scene data stored in the server is configured to render the game scene when the game scene image stored corresponding to the same identification code is photographed. Therefore, the terminal, in response to an editing instruction for a certain game scene image, sends the data acquisition request carrying the identification code to the server to request the game scene data of the game scene image.

302. The server queries, based on the data acquisition request, game scene data stored corresponding to the identification code and sends the game scene data to the terminal.

The terminal is configured to receive the game scene data and load the game scene data to restore a game scene of the game scene image. In response to an adjusting operation for game elements in the game scene, the game elements in the game scene are adjusted and an adjusted game scene is displayed. In response to an image saving instruction, the game scene image is updated based on an adjusted game scene.

In the solutions provided by the examples of this application, in a game running process, when the game scene is photographed to obtain the game scene image, the server will store the game scene data corresponding to the game scene image. When the game scene image is edited, even at the end of the game, the terminal is interacted with the server to acquire the game scene data. The terminal also can restore the game scene when the game scene image is photographed based on the game scene data, so that the game elements in the game scene are adjusted conveniently, and the content included in the displayed game scene is adjusted. Then the content included in the adjusted game scene changes. Furthermore, based on the adjusted game scene, the game scene image is updated, so that the content included in the updated game scene image is the same as the content included in the adjusted game scene. This image editing mode edits the substantial content included in the game scene image to realize a solution for delayed editing of the game scene image, which not only guarantees that in the game ongoing process, the game scene image can be timely photographed, without interrupting the ongoing game, guaranteeing normal proceeding of the game, but also can guarantee the display effect of the obtained game scene image, so that the user experience is further improved. Moreover, the game scene data corresponding to the game scene image is stored in the server, so that the storage resource of the terminal can be saved.

Based on the examples shown in FIG. 2 and FIG. 3, in the examples of this application, when the terminal photographs the displayed game scene to obtain the game scene image, the server will store the game scene data of the game scene image. In the subsequent process of editing the game scene image, the terminal is interacted with the server to acquire the game scene image of the game scene data from the server, so as to edit the game scene image. The specific process is described in detail in the examples below.

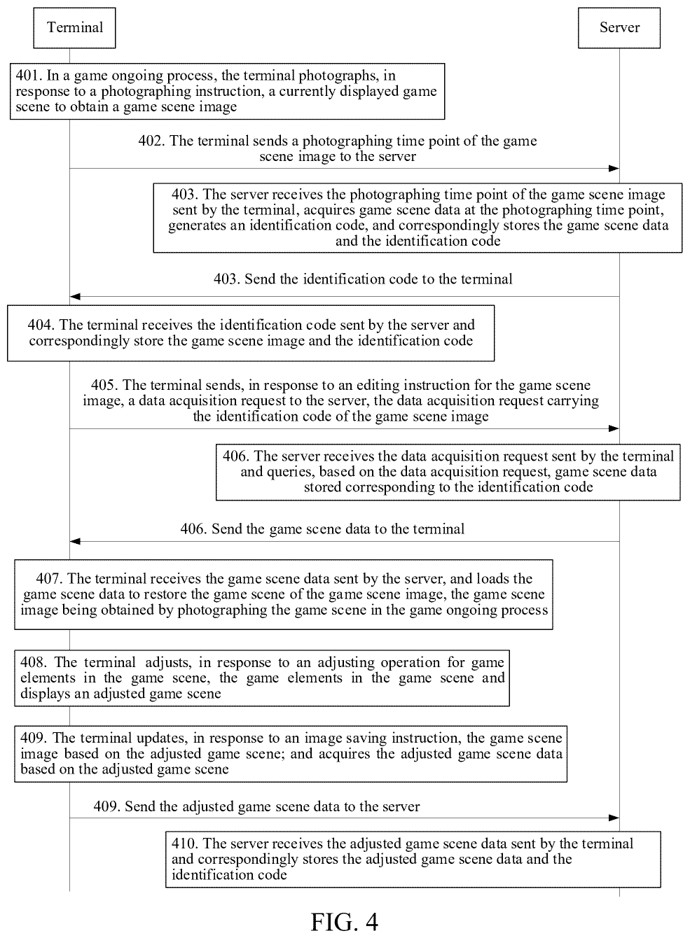

FIG. 4 is a flowchart of another method for editing a game scene image provided by an example of this application. Taking the method being executed by a terminal and a server as an example, as shown in FIG. 4, the method includes:

401. In a game ongoing process, the terminal photographs, in response to a photographing instruction, a currently displayed game scene to obtain a game scene image.

In the example of this application, the terminal can run the game, and in the game running process, the game scene will be displayed. The photographing instruction indicates to photograph the displayed game scene to generate the game scene image. The terminal receives the photographing instruction to photograph the currently displayed game scene so as to obtain the game scene image including the content of the currently displayed game scene.

In a possible implementation, the terminal, in the game ongoing process, displays the game scene of the game in a scene display interface. A photographing option is displayed in the scene display interface. Operation 401 includes: in the game ongoing process, in response to a triggering operation for the photographing option in the scene display interface, the currently displayed game scene in the scene display interface is photographed to obtain the game scene image.

In the example of this application, the scene display interface not only displays the game scene of the game, but also displays the photographing option, so as to acquire the game scene image through the photographing option in the game ongoing process, so that the photographing convenience is guaranteed.

402. The terminal sends a photographing time point of the game scene image to the server.

The photographing time point is a time point at which the game scene image is photographed by the terminal in the game ongoing process. The photographing time point is represented by a time in a real environment or is identified by a time in the game. For example, the photographing time point is 5 PM, Day XX, Month XX; or the photographing time point is the 30th minute in any round of game ongoing process.

403. The server receives the photographing time point of the game scene image sent by the terminal, acquires game scene data at the photographing time point, generates an identification code, correspondingly stores the game scene data and the identification code, and sends the identification code to the terminal.

In the example of this application, the server receives the photographing time point of the game scene image sent by the terminal, i.e., indicating that the terminal has generated the game scene image. The photographing time point is a time point at which the terminal photographs the game scene image, so the server acquires the game scene data at the photographing time point. The game scene data at the photographing time point is configured to render the game scene displayed when the game scene image is photographed, i.e., the server acquires the game scene data of the game scene image, generates the identification code with uniqueness, correspondingly stores the game scene data and the identification code to search for the corresponding game scene data through the identification code later, and sends the identification code to the terminal, so that the terminal correspondingly stores the identification code and the game scene data.

In a possible implementation, the process of acquiring the game scene data at the photographing time point includes: a time period including the photographing time point is determined based on the photographing time point; and the game scene data within the time period is acquired.

The time period is any time period. For example, the time period is a time period between the time point earlier than the photographing time point and the photographing time point, or the time period is a time period between the photographing time point and a time point later than the photographing time point, or the time period is a time period between the time point earlier than the photographing time point and a time point later than the photographing time point. For example, the time period is a time period taking the photographing time point as a center time point with any duration. For example, the duration is a time period of 30 s, i.e., the duration of the time period is 30 s. The time point at the 15 s of the time period is the center time point, i.e., the photographing time point.

In the example of this application, the time period including the photographing time point is determined based on the photographing time point and the game scene data within the time period is acquired, so that the game scene within the time period can be restored subsequently based on the game scene data, and the game scene image is updated based on the game scene within the time period, rather than merely updating the game scene image based on the game scene displayed at the photographing time point of the game scene image. Therefore, the user can select the game scene at any time point within the time period to update the game scene image, which, thus, guarantees the flexibility of image edition.

In addition, the game scene data within the time period including the photographing time point is acquired, so that the user can select any freeze-frame time point to generate a new game scene image when editing the image. Thus, even the user has missed the optimal picture when triggering the photographing instruction in the game ongoing process, the previously displayed picture can still be restored, which facilitates the user to photograph the satisfactory game scene image, so that the user experience is enhanced.

In one embodiment, the terminal further sends the object identifier logged in by the terminal to the server when sending the photographing time point of the game scene image to the server. Then, when receiving the photographing time point of the game scene image, the server further receives the object identifier sent by the terminal, so that the process of acquiring the game scene data at the photographing time point includes: a camera position of the object identifier within the time period is determined, the camera position being a position of a virtual camera in the game scene displayed by the terminal within the time period in the game ongoing process; a virtual object of the virtual camera within a photographing range of the camera position is determined; and the game scene data is constituted by object data of the virtual object within the time period.

The virtual object is any object in the game scene, for example, the virtual object includes a movable virtual object or an immovable virtual object. The movable virtual object includes a virtual character, a virtual animal, a virtual vehicle, and the like. The immovable virtual object includes a virtual building, a virtual tree, and the like. The object identifier logged in by the terminal may be a game account number of a player or another identifier, which is not limited herein.

In the example of this application, the virtual camera is configured to photograph the game scene. The game scene displayed by the terminal in the game ongoing process is the game scene photographed by the virtual camera. When receiving the object identifier sent by the terminal and the photographing time point, the server can acquire the camera position of the virtual camera when the game scene is displayed within the time period in a case that the terminal logs in the object identifier. The camera position within the time period may either remain constant or change with time. For each camera position, the virtual object of the virtual camera within the photographing range of the camera position is determined. The virtual object is the virtual object displayed by the terminal in the game ongoing process. The game scene data is constituted by the object data of the virtual object within the time period, so that the game scene data includes the game scene data of the game scene displayed by the terminal within the time period in the game ongoing process, and/or does not include the game scene data of the game scene not displayed by the terminal to prevent excessive storage resources from being occupied when the game scene data is subsequently stored due to a too large data volume of the obtained game scene data, so that the storage resources are saved.

The example of this application is illustrated by merely taking the game scene data which is the game scene data of the game scene displayed by the terminal within the time period in the game ongoing process as an example. In another embodiment, the game scene data acquired by the server further includes the game scene data of the game scene not displayed by the terminal, which is not limited herein.

In a possible implementation, the process of generating the identification code includes: The identification code is constituted by the object identifier and the game time point or the identification code is constituted by the object identifier, a game session number, and the game time point, or the stored data is processed by a preset algorithm to obtain the identification code, which is not limited herein.

The object identifier is an object identifier logged in by the terminal. The game time point is a time point when the game scene image is photographed. The time session number is an ongoing game session when the game scene image is photographed in a case that the game is a multi-session game.

404. The terminal receives the identification code sent by the server and correspondingly stores the game scene image and the identification code.

In the example of this application, the identification code is a unique identifier through which the terminal acquires the game scene data of the game scene image from the server. Upon receiving the identification code sent by the server, the terminal correspondingly stores the game scene image and the identification code, so as to acquire the game scene data of the game scene image from the server based on the identification code when editing the game scene image later.

405. The terminal sends, in response to an editing instruction for a certain game scene image, a data acquisition request to the server, the data acquisition request carrying the identification code of the game scene image.

In the example of this application, the terminal can edit the game scene image generated in the game running process, and in response to the editing instruction for the game scene image, is interacted with the server to send the data acquisition request carrying the identification code of the game scene image to the server, so that the server can return the game scene data of the game scene image.

In a possible implementation, operation 405 includes: at the end of the game, in response to an image viewing instruction, an image list is displayed. The image list includes at least one game scene image. In response to a selection operation for any game scene image in the image list, the selected game scene image and an edit option are displayed in the image display interface. In response to a trigger operation for the edit option, the data acquisition request is sent to the server.

The game scene images in the image list all are photographed in the game ongoing process, each game scene image corresponding to the identification code. For example, the image list is a game photo album of the game. The game scene image is a game photo. The game photo album includes at least one game photo. In one embodiment, the plurality of game scene images in the image list are photographed in a same game ongoing process, or the plurality of game scene images are photographed in different game ongoing processes. For example, the image list includes three game scene images. The three game scene images are photographed in the same game ongoing process, or the three game scene images are photographed in three game ongoing processes, respectively. The image display interface is configured to display the game scene image photographed in the game ongoing process. The edit option is configured to edit a currently displayed game scene image to adjust the content included in the game scene image.

In the example of this application, at the end of the game, the game scene image generated in the game ongoing process can be viewed, and any game scene image can be selected for editing to adjust the content included in the selected game scene image. When the game scene image is edited, through interaction with the server, the terminal sends the data acquisition request to the server so as to acquire the game scene data of the game scene image from the server, so that the game scene of the game scene image can be restored. The game scene image is updated based on the game scene.

In one embodiment, a game application served by the server is installed in the terminal. The terminal can play the game through the game application. The game scene image photographed by the terminal in the game ongoing process is stored in an image system of the game application. The image system can be accessed through the game application to display the image list in the game scene interface.

In one embodiment, the image display interface further displays other functional options. For example, the image display interface further displays a style adjust option, a local save option, a share option, and the like. The style adjust option is configured to adjust the style of the game scene image, for example, color style, light style, and the like of the game scene image. The local save option is configured to save the game scene image in the game in a local photo album of the terminal. For example, the game scene image photographed in the game ongoing process is saved in the game application. In a case that the image display interface displays the selected game scene image and the local save option, a trigger operation for the local save option saves the selected game scene image in the photo album of the terminal. The share option is configured to share the game scene image displayed in the image display interface. For example, based on the share option, the game scene image displayed in the image display interface is shared to a website or with friends and the like.

406. The server receives the data acquisition request sent by the terminal, queries, based on the data acquisition request, the game scene data stored corresponding to the identification code and sends the game scene data to the terminal.

In the example of this application, the game scene data stored corresponding to the identification code in the server is the game scene data requested by the data acquisition request, i.e., the game scene data of the game scene image. The server queries the game scene data stored corresponding to the identification code based on the data acquisition request and sends the game scene data to the terminal, so that the terminal restores the corresponding game scene based on the game scene data.

407. The terminal receives the game scene data sent by the server, and loads the game scene data to restore the game scene of the game scene image, the game scene image being obtained by photographing the game scene in the game ongoing process.

In the example of this application, the terminal, in response to the editing instruction for the game scene image, interacts with the server, loads the game scene data of the game scene image upon acquiring the game scene data of the game scene image from the server to restore the game scene displayed when the game scene image is obtained by photographing the game scene in the game ongoing process, so that the content included in the game scene image is adjusted conveniently by adjusting the game elements in the game scene later.

In a possible implementation, the game scene data is game scene data within the time period including the photographing time point of the game scene image. The terminal loads the game scene data of the game scene image to restore the game scene of the game scene image and the initially displayed content of the restored game scene is the same as the content included in the game scene image. The game scene at any time point within the time period can also be displayed subsequently by adjusting the time point.

In a possible implementation, a game application is installed in the terminal. The game application includes an art resource, so that the process of restoring the game scene includes: the terminal calls the art resource in the game application, and based on the art resource, loads the game scene data to restore the game scene of the game scene image.

The art resource is configured to render a resource of the game scene. For example, the art resource includes texture of buildings, data of virtual plants, and the like in the game scene. In the example of this application, when the game application is installed in the terminal, an installation package of the game application includes the art resource. The art resource is a basic resource used to render the game scene, so as to render the game scene through the art resource in the game application without interaction between the terminal and the server to acquire the art resource, so that the network resource is saved, and it also can be guaranteed that the terminal can normally render the game scene.

408. The terminal adjusts, in response to an adjusting operation for game elements in the game scene, the game elements in the game scene and displays an adjusted game scene.

In a possible implementation, operation 408 includes at least one of the following items:

First item: in response to a focal length adjusting operation of the virtual camera in the game, a focal length of the virtual camera is adjusted, and a game scene photographed by the virtual camera based on an adjusted focal length is displayed.

In the example of this application, the game scene displayed in the game ongoing process is photographed by the virtual camera in the game. In a case that the game scene of the game scene image is restored, by adjusting the focal length of the virtual camera, a size of the virtual object photographed by the virtual camera in the game scene changes, so that a size of the virtual object in the adjusted game scene changes, i.e., the content of the game scene changes.

Second item: in response to the position adjusting operation of the virtual camera in the game, the position of the virtual camera is adjusted, and a game scene photographed by the virtual camera at an adjusted position is displayed.

In the example of this application, the game scene displayed in the game ongoing process is photographed based on the virtual camera in the game. In a case that the game scene of the game scene image is restored, the camera positions of the virtual camera are different, so that the photographed game scenes are different. By adjusting the camera position of the virtual camera, i.e., adjusting the position of the virtual camera in the game scene, the game scenes photographed by the virtual camera before and after adjustment are different, so that the content included in the game scene photographed by the virtual camera at the adjusted position changes. For example, in a game scene photographed by the virtual camera before adjustment, a virtual object 1 is displayed at a middle position of the game scene. The virtual camera is adjusted to move rightward, so that in a game scene photographed by the virtual camera at the adjusted position, the virtual object 1 is displayed on a left position of the game scene, and other virtual objects on a right side of the virtual object 1 are displayed.

Third item: in response to a viewing angle adjusting operation for the virtual camera in the game, a photographing viewing angle of the virtual camera is adjusted and a game scene photographed by the virtual camera based on an adjusted photographing viewing angle is displayed.

In the example of this application, adjusting the photographing viewing angle of the virtual camera refers to keeping the position of the virtual camera unchanged and rotating the virtual camera to adjust the photographing viewing angle of the virtual camera. For example, the virtual camera before adjustment photographs toward the east and the adjusted virtual camera photographs toward the west. By adjusting the photographing viewing angle of the virtual camera in the game to adjust the game scene photographed by the virtual camera, the content included in the game scene photographed by the virtual camera based on the adjusted photographing viewing angle changes.

Fourth item: in response to a position adjusting operation for a first virtual object in the game scene, a position of the first virtual object is adjusted and an adjusted game scene is displayed.

The first virtual object is any virtual object displayed in the game scene. In the example of this application, in a case that the game scene of the game scene image is restored, the position of the virtual object displayed in the game scene can be adjusted, so that the content included in the adjusted game scene changes.

Fifth item: in response to a posture adjusting operation for a second virtual object in the game scene, a posture of the second virtual object is adjusted and an adjusted game scene is displayed.

The second virtual object is any virtual object displayed in the game scene. The second virtual object may be either the same as the first virtual object or different from the first virtual object. The posture of the second virtual object is the appearance, action, and the like of the second virtual object shown in the game scene.

In the example of this application, in a case that the game scene of the game scene image is restored, the posture of the virtual object displayed in the game scene can be adjusted, so that the posture of the virtual object included in the adjusted game scene changes, i.e., the content included in the adjusted game scene changes. In a possible implementation, a skeleton state of the second virtual object is adjusted to adjust the posture of the second virtual object.

Sixth item: in a case that a scene progress bar of the game scene is displayed, in response to a time selection operation for the scene progress bar, a freeze-frame time point selected from the scene progress bar is determined, and a game scene at the freeze-frame time point is displayed. The scene progress bar includes a photographing time point of the game scene image and a time point earlier or later than the photographing time point.

The scene progress bar includes a plurality of time points. In addition to the photographing time point of the game scene image, the scene progress bar further includes the time point earlier or later than the photographing time point. In one embodiment, the scene progress bar corresponds to one time period. The time period is a time period between any time point earlier than the photographing time point and the photographing time point, or the time period is a time period between the photographing time point and any time point later than the photographing time point, or the time period is a time period between any time point earlier than the photographing time point and any time point later than the photographing time point.

In the example of this application, the game scene data of the game scene image is the scene data at the time point included in the scene progress bar. In a case that the game scene of the game scene image is restored, by adjusting the time point on the scene progress bar, the game scene at the time point selected on the scene progress bar can be stored, i.e., the game scene displayed at the time point in the game ongoing process can be restored. The selected time point is the freeze-frame time point, so that the terminal can display the game scene at the freeze-frame time point, i.e., reproduce the game scene previously displayed at the freeze-frame time point, and thus, the content of the adjusted game scene changes.

The example of this application is merely illustrated taking the above six items as examples to adjust the game elements. In another embodiment, the above six items may be combined in different manners. For example, any two of the above six items are combined or the above six items are combined.

The example of this application provides various adjusting modes for the game elements. Any one or more adjusting modes can be selected to adjust the game elements in the game scene, so that the content included in the game scene changes, the adjusting mode is enriched, and various demands of the user can be met, which further improves the user experience.

In a possible implementation, the restored game scene is displayed in the scene display interface, and the scene display interface displays a plurality of adjusting options. Different adjusting options are configured to trigger different adjusting operations, and operation 408 includes: in response to a triggering operation for any adjusting option in the scene display interface, the game elements in the game scene are adjusted and the adjusted game scene is displayed.

The plurality of adjusting options include a focal length adjusting option, a camera position adjusting option, a viewing angle adjusting option, an object position adjusting option, a posture adjusting option, and the like. The focal length adjusting option is configured to adjust the focal length of the virtual camera in the game and detecting the triggering operation for the focal length adjusting option is equivalent to detecting the focal length adjusting operation of the virtual camera in the game; the camera position adjusting operation is configured to adjust the camera position of the virtual camera in the game and detecting the triggering operation for the camera position distance adjusting operation is equivalent to detecting the camera position adjusting operation of the virtual camera in the game; the viewing angle adjusting option is configured to adjust the photographing viewing angle of the virtual camera in the game and detecting the triggering operation for the viewing angle adjusting option is equivalent to detecting the viewing angle adjusting operation of the virtual camera in the game; the position adjusting option is configured to adjust the position of the virtual object in the game scene and detecting the triggering operation for the position adjusting option is equivalent to detecting the position adjusting operation of the virtual object in the game scene; and the posture adjusting option is configured to adjust the posture of the virtual object in the game scene and detecting the triggering operation for the posture adjusting option is equivalent to detecting the posture adjusting operation of the virtual object in the game scene.

409. The terminal, in response to an image saving instruction, updates the game scene image based on an adjusted game scene; and acquires the adjusted game scene data based on the adjusted game scene and sends the adjusted game scene data to the server.

In the example of this application, after adjusting the displayed game scene, in response to the image saving instruction, based on the adjusted game scene, i.e., based on a currently displayed game scene, a new game scene image is generated. The content included in the new game scene image is the same as the content included in the currently displayed game scene. The previous game scene image is replaced with the new game scene image to update the previous game scene image. Moreover, when the game scene is adjusted, the game scene data of the game scene will change therewith. In a case that the image saving instruction is received, it indicates that there will be no adjustment on the game scene, so that the adjusted game scene data is acquired based on the adjusted game scene, i.e., the adjusted game scene data is configured to restore the adjusted game scene, and the adjusted game scene data is sent to the server and stored by the server, so that the adjusted game scene data can be subsequently acquired to restore the adjusted game scene.

In a possible implementation, the process of updating the game scene image includes: the terminal replaces the game scene image with the new game scene image and correspondingly stores the new game scene image and the identification code; or the terminal correspondingly stores the new game scene image and the game scene image and the identification code, and sets a historical identifier for the game scene image to indicate that the game scene image is a historical version.

In the example of this application, upon receiving the new game scene image, the terminal replaces the original game scene image with the new game scene image, so that the terminal stores the new game scene image and deletes the original game scene image to complete edition of the original game scene image, thereby saving the storage resources. Alternatively, the new game scene image and the previous game scene image and the identification code all are correspondingly stored to enrich the versions of the stored game scene image to provide a plurality of versions of game scene images, thereby improving the user experience.

In a possible implementation, the terminal will adjust the loaded game scene data in real time in the process of adjusting the game elements in the game scene, i.e., the method further includes: the terminal loads the game scene data, upon restoring the game scene of the game scene image, in response to the adjusting operation for the game elements in the game scene, adjusts the game elements in the game scene and adjusts the loaded game scene data.

In the example of this application, the loaded game scene data in the process of adjusting the game scene will change therewith. In a case that the image saving instruction is received, it indicates that there will be no adjustment on the game scene, so that the loaded game scene data is acquired, i.e., the adjusted game scene data is acquired.

In a possible implementation, the restored game scene is displayed in the scene display interface, and the scene display interface further displays the image saving option. Detecting the triggering operation for the image saving option is equivalent to receiving the image saving instruction.

410. The server receives adjusted game scene data sent by the terminal and correspondingly stores the adjusted game scene data and the identification code.

In the example of this application, the server receives the adjusted game scene data sent by the terminal and then correspondingly stores the adjusted game scene data and the identification code, so that the terminal can subsequently acquire the adjusted game scene data from the server based on the identification code.

In a possible implementation, the server replaces the game scene data stored corresponding to the identification code with the adjusted game scene data; or the server correspondingly stores the adjusted game scene data and the game scene data before adjustment and the identification code, and sets a historical identifier for the game scene data before adjustment to indicate that the game scene data is a historical version.

In the example of this application, the server stores one game scene data corresponding to the identification code, and upon receiving the adjusted game scene data sent by the terminal, replaces the game scene data stored corresponding to the identification code with the adjusted game scene data, so that the game scene data stored in the server is the latest game scene data, guaranteeing the accuracy of the game scene data stored in the server. Moreover, the game scene data before adjustment can also be deleted to save the storage resources.

In the example of this application, the server can store a plurality of game scene data corresponding to the identification code and will also set the historical identifier for the game scene data before adjustment, so that the server can determine the game scene data before adjustment based on the historical identifier and determines the version of each of the game scene data. The stored game scene data is enriched, and the terminal can be provided with various versions of game scene data, so that the terminal can be subsequently provided with accurate game scene data.

In a possible implementation, after operation 410, the terminal also can adjust the updated game scene image again. In the adjusting process, the terminal will interact with the server to acquire the adjusted game scene data. That is, according to the above operations 405-410, the terminal interacts with the server again to update the game scene image again and update the game scene data stored in the server again.

In the solutions provided by the examples of this application, in a game running process, after the game scene is photographed to obtain the game scene image, the game scene image can also be edited. When the game scene image is edited, even at the end of the game, the game scene when the game scene image is photographed can also be restored, so that the game elements in the game scene are adjusted conveniently, and the content included in the displayed game scene is adjusted. Then the content included in the adjusted game scene changes. Furthermore, based on the adjusted game scene, the game scene image is updated, so that the content included in the updated game scene image is the same as the content included in the adjusted game scene. This image editing mode edits the substantial content included in the game scene image to realize a solution for delayed editing of the game scene image, which not only guarantees that in the game ongoing process, the game scene image can be timely photographed, without interrupting the ongoing game, guaranteeing normal proceeding of the game, but also can guarantee the display effect of the obtained game scene image, so that the user experience is further improved.

In the example of this application, the camera position of the virtual camera when the terminal displays the game scene within the time period is acquired, and the virtual object of the virtual camera within the photographing range of the camera position is determined. The virtual object is a virtual object displayed by the terminal in the game ongoing process. The game scene data is constituted by the object data of the virtual object within the time period, so that the game scene data includes the game scene data of the game scene displayed by the terminal within the time period in the game ongoing process, and/or does not include the game scene data of the game scene not displayed by the terminal to prevent excessive storage resources from being occupied when the game scene data is subsequently stored due to a too large data volume of the obtained game scene data, i.e., the storage resources are saved.

In the example of this application, the game scene image and the identification code are correspondingly stored in the terminal. The game scene data and the identification code are correspondingly stored in the server. The identification code serves as a unique identifier through which the server acquires the game scene data of the game scene image. Based on the identification code, the game scene data of the game scene image can be acquired from the server. This separate storage mode can save the storage resources of the terminal. Moreover, the identification code and the game scene image and the game scene data are correspondingly stored, so that the scene data of the game scene image can be acquired through the identification code, and therefore, the accuracy of the acquired game scene data is guaranteed.

Moreover, the terminal, in response to the game scene image photographed according to the photographing instruction, interacts with the server. The server acquires the corresponding game scene data based on the photographing time point and generates the identification code with uniqueness, so that the server correspondingly stores the game scene data and the identification code, and the terminal correspondingly stores the game scene image and the identification code, so that the terminal can subsequently acquire the game scene data of the game scene image from the server based on the identification code, thereby further guaranteeing the accuracy of the subsequently acquired game scene data.

Based on the example shown in FIG. 2, in the example of this application, when the terminal photographs the game scene to obtain the game scene image, it will also store the game scene data locally, and then edits the game scene image in combination with the game scene data. The specific process is described in detail in the examples below.

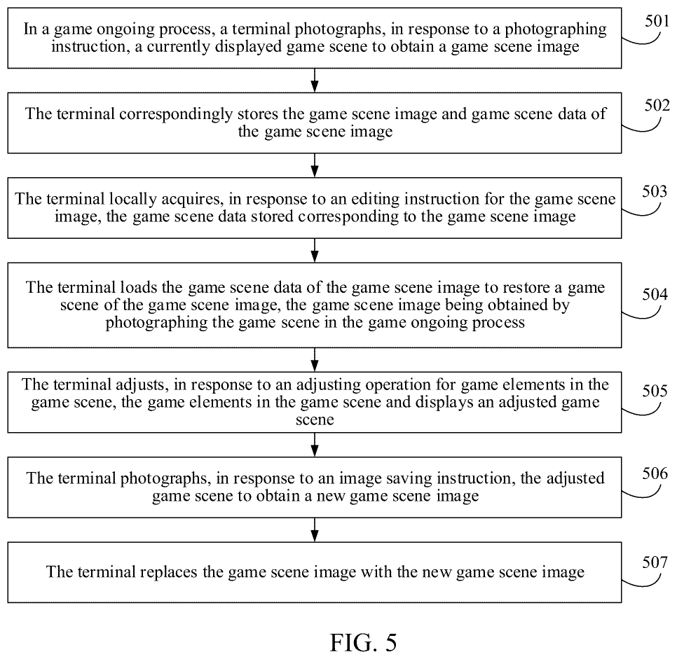

FIG. 5 is a flowchart of a method for editing a game scene image provided by an example of this application. Taking the method being executed by a terminal as an example, as shown in FIG. 5, the method includes:

501. In a game ongoing process, a terminal photograph, in response to a photographing instruction, a currently displayed game scene to obtain a game scene image.

Operation 501 is similar to the above operation 401, which is not repeatedly described herein.

502. The terminal correspondingly stores the game scene image and game scene data of the game scene image.

In the example of this application, the terminal acquires the game scene data of the game scene image when the game scene image is generated, i.e., acquires the game scene data of the currently displayed game scene, or the game scene data is the game scene data at the photographing time point of the game scene image, i.e., the game scene data when the game scene image is photographed. The terminal correspondingly stores the game scene image and the game scene image, so that when the game scene image is edited subsequently, the terminal acquires the locally stored game scene data to restore the game scene of the game scene image without interacting with other devices, and therefore, the real-time restoring of game scene is guaranteed, and the user experience is improved.

503. The terminal locally acquires, in response to an editing instruction for the game scene image, the game scene data stored corresponding to the game scene image.

In the example of this application, the terminal stores the game scene image generated in the game ongoing process and the game scene data stored corresponding to the game scene image. The terminal, when editing any game scene image, can locally acquire the game scene data stored corresponding to the game scene image.

504. The terminal loads game scene data of the game scene image to restore a game scene of the game scene image, the game scene image being obtained by photographing the game scene in the game ongoing process.

Operation 504 is similar to the above operation 407, which is not repeatedly described herein.

The example of this application is illustrated taking the locally stored game scene image photographed by the terminal in the game ongoing process and the corresponding game scene data as examples. In another embodiment, it is not needed to execute the above operations 501-504 but other modes are adopted. In response to the editing instruction for the game scene image, the terminal loads the game scene data of the game scene image to restore the game scene of the game scene image.

505. The terminal adjusts, in response to an adjusting operation for game elements in the game scene, the game elements in the game scene and displays an adjusted game scene.

Operation 505 is similar to operation 408, which is not repeatedly described herein.

506. The terminal photographs, in response to an image saving instruction, the adjusted game scene to obtain a new game scene image.

In the example of this application, after adjusting the displayed game scene, the contents included the adjusted game scene and the previous game scene change. In response to the image saving instruction, indicating that the user wants to photograph the adjusted game scene to obtain a game scene image, the user photographs the adjusted game scene to obtain the new game scene image. The content included in the new game scene image is the same as the content included in the adjusted game scene.

In a possible implementation, operation 506 includes: in response to the image saving instruction, a screenshot of a picture currently displayed by the terminal is taken to obtain a screenshot image. The screenshot image is cropped to obtain a new game scene image.

In the example of this application, in the game ongoing process, in addition to the game scene, the picture displayed by the terminal may further include other information. For example, the picture displayed by the terminal further includes a menu bar of the game application, a menu bar of the terminal, and the like. The content included in the screenshot image obtained by screenshotting the picture displayed by the terminal is the same as the content included in the picture displayed by the terminal. Since the screenshot image may include other information except for the game scene, upon obtaining the screenshot image, the screenshot image is cropped, so that the new game scene image obtained through cropping merely includes the content included in the game scene, and therefore, the display effect of the obtained game scene image is guaranteed.

507. The terminal replaces the game scene image with the new game scene image.

In the example of this application, upon receiving the new game scene image, the terminal replaces the original game scene image with the new game scene image, so that the terminal stores the new game scene image and deletes the original game scene image to complete edition of the original game scene image, so as to locally store the latest game scene image, thereby saving the storage resources of the terminal.

In a possible implementation, operation 507 includes: the terminal replaces the game scene image with the new game scene image so as to correspondingly store the new game scene image and the game scene data.

In the example of this application, the terminal correspondingly stores the game scene image and the game scene data, and upon editing the game scene image to obtain the new game scene image, replaces the original game scene image with the new game scene image, so that the new game scene image and the game scene data are correspondingly stored. Therefore, the new game scene image can be edited again subsequently based on the game scene data to meet a re-editing demand of the user, so that the user experience is improved.

In one embodiment, the method further includes: the terminal, in response to the image saving instruction, acquires the adjusted game scene data based on the adjusted game scene, and replaces the game scene data of the game scene with the adjusted game scene data, so that the terminal correspondingly stores the new game scene image and the adjusted game scene data.

The example of this application is illustrated taking replacement of the original game scene image with the new game scene image as an example. In another embodiment, it is not needed to execute the above operations 506-507 but other modes are adopted. In response to the image saving instruction, based on the adjusted game scene, the game scene image is updated.

The example of this application is merely illustrated taking edition of the game scene image based on the game scene data as an example. In another embodiment, after operation 502, the terminal may also delete the locally stored game scene data, so that the storage resources are saved.

In a possible implementation, the method further includes: from the end of the game, in a case that a duration reaches a target duration and the editing instruction for the game scene image is not received, the game scene data of the game scene image is deleted.

The target duration is any duration. For example, the target duration is 3 days or 2 days.

In the example of this application, the terminal correspondingly stores the game scene image photographed in the game ongoing process and the game scene data, and the stored game scene data will occupy a lot of storage resources of the terminal. Given that in the game ongoing process, if the user interrupts the game to edit the game scene image, it will affect normal proceeding of the game. Therefore, it is timed from the end of the game, if the duration reaches the target duration, and in the process, the editing instruction for the game scene image is not received, it indicates that the user may not edit the game scene image, so that the game scene data of the game scene image is deleted to prevent occupying the storage resources of the terminal, thereby saving the storage resources of the terminal.

In the solutions provided by the examples of this application, in a game running process, after the game scene is photographed to obtain the game scene image, the game scene image can also be edited. When the game scene image is edited, even at the end of the game, the game scene when the game scene image is photographed can also be restored, so that the game elements in the game scene are adjusted conveniently, and the content included in the displayed game scene is adjusted. Then the content included in the adjusted game scene changes. Furthermore, based on the adjusted game scene, the game scene image is updated, so that the content included in the updated game scene image is the same as the content included in the adjusted game scene. This image editing mode edits the substantial content included in the game scene image to realize a solution for delayed editing of the game scene image, which not only guarantees that in the game ongoing process, the game scene image can be timely photographed, without interrupting the ongoing game, guaranteeing normal proceeding of the game, but also can guarantee the display effect of the obtained game scene image, so that the user experience is further improved.

Moreover, the terminal will locally store the photographed game scene image and the game scene data in the game ongoing process, so that when the game scene image is edited subsequently, the terminal directly acquires the game scene data without interacting with other devices, and therefore, the real-time restoring of the game scene is guaranteed, and the user experience is improved.

In the example of this application, the terminal correspondingly stores the game scene image photographed in the game ongoing process and the game scene data, and the stored game scene data will occupy a lot of storage resources of the terminal. Given that in the game ongoing process, if the user interrupts the game to edit the game scene image, it will affect normal proceeding of the game. Therefore, it is timed from the end of the game, if the duration reaches the target duration, and in the process, the editing instruction for the game scene image is not received, it indicates that the user may not edit the game scene image, so that the game scene data of the game scene image is deleted to prevent occupying the storage resources of the terminal, thereby saving the storage resources of the terminal.

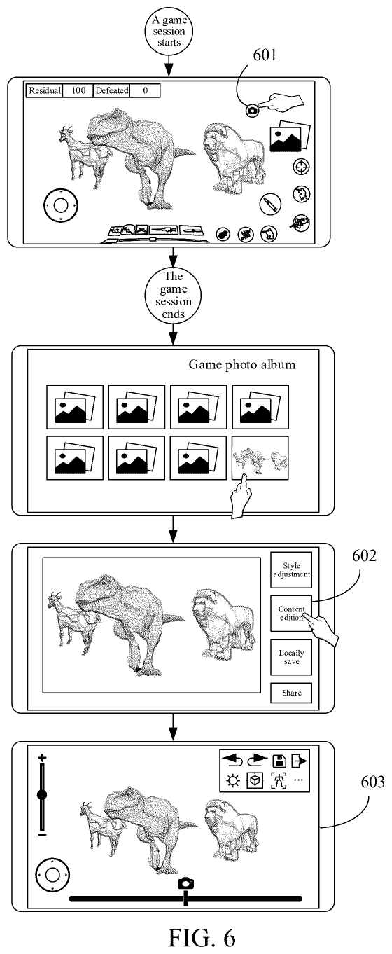

Based on the examples shown in FIG. 2 to FIG. 5, the example of this application further provides a flowchart of a method for editing a game scene image. As shown in FIG. 6, taking the game scene image being a game photo as an example, the method includes:

Operation 1. The terminal runs the game application, and a player clicks/taps a displayed photographing button 601 to generate a game photo through the terminal for a scene to be photographed in the game ongoing process and stores the game photo in the game photo album of the game application.

Operation 2. The player continues the ongoing game through the terminal and accesses the game photo album through the terminal at the end of the game, and the terminal displays a game photo list in the game photo album, the game photo listing including at least one game photo.

Operation 3. The player selects any game photo through the terminal, and the terminal displays the game photo and a plurality of function options. In response to a triggering operation for a content editing option 602 in the plurality of function options, the terminal enters a photo editing mode to restore a game scene 603 of the selected game photo.

Operation 4. In the photo editing mode, the player can adjust the freeze-frame time point of the photo, the action, expression, and apparel of the virtual object, details of the virtual object in the game scene, and the like through the terminal.

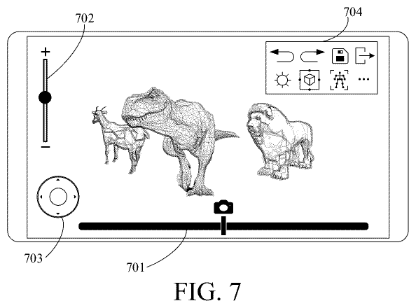

As shown in FIG. 7, the terminal enters the photo editing mode to display the restored game scene, a scene progress bar 701, a focal length adjusting control 702, a position moving option 703 and a plurality of adjusting function options 704, for example, an undo option, a restore option, a save option, an exit option, a light source adjusting option, a position adjusting option, and a skeleton adjusting option. The restored game scene is adjusted through the displayed scene progress bar 701, the focal length adjusting control 702, and the plurality of adjusting function options. The scene progress bar 701 is configured to adjust the freeze-frame time point of the game scene to display a game scene at the freeze-frame time point. The focal length adjusting control 702 is configured to adjust the focal length of the virtual camera in the game, and the position moving option 703 is configured to move the virtual camera to adjust the camera position of the virtual camera in the game. The undo option is configured to undo the previous adjusting operation, the restore option is configured to restore the undone adjusting operation, and the save option is configured to trigger the image saving instruction, i.e., generate the new game photo based on the currently displayed game scene; the exit option is configured to exit the photo editing mode and the light source adjusting option is configured to adjust a light source in the game scene; the position adjusting option is configured to adjust the position of the virtual object in the game scene, and the skeleton adjusting option is configured to adjust the posture of the virtual object in the game scene.

Operation 5. After the edition is completed, the player clicks/taps the save option displayed by the terminal to generate the new game photo based on an adjusted game scene.

In the example of this application, when having a photographing will in the gaming process, the player may click/tap the photographing button and continue the ongoing game without interrupting the ongoing game to adjust the game scene. When the game photo is saved, the game scene data of the game photo will be saved. Then the player edits the game photo at an idle time at the end of the game. The player enters a photo editing mode to restore the game scene of the game photo and edit the content of the restored game scene to generate a new game photo, so that the new game photo meets the will of the player. This solution for delayed editing of the game photo will not affect normal proceeding of the game and can guarantee the display effect of the game photo. Therefore, the player is satisfied, so that the user experience is improved.

Based on the examples shown in FIG. 2 to FIG. 6, the example of this application describes the adjusting process of the game scene in detail.
1. The virtual camera in the game is allowed to be adjusted, so that the game photo is recomposed again.

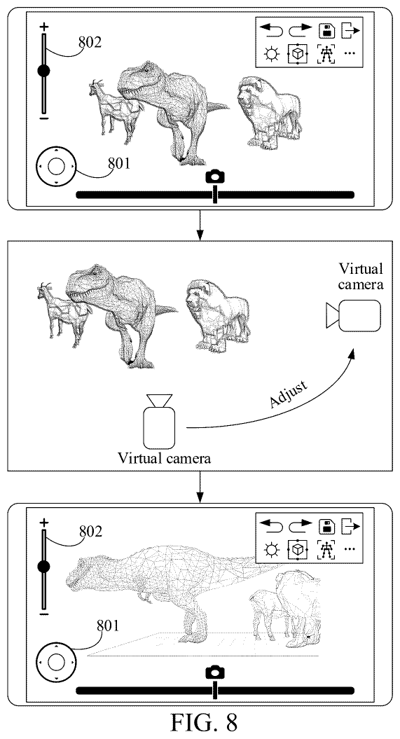

In a case that the terminal restores the game scene of the game scene image, the player can adjust the photographing viewing angle, the focal length, the position, and the like of the virtual camera in the game through the terminal, so that the content included in the adjusted game scene changes, and the secondary composition of the game photo is realized. As shown in FIG. 8, a front face of the virtual animal is displayed in the game scene, and in this case, it is equivalent to the virtual camera photographing fin front of the virtual animal. Through the position moving option 801, the virtual camera is moved rightward, and the screen of the terminal slides to rotate the photographing viewing angle of the virtual camera, so that the virtual camera photographs on the right side of the virtual animal. Through the focal length adjusting control 802, the focal length of the virtual camera is adjusted, and a side face of the virtual animal is displayed in the adjusted game scene. As shown in FIG. 9, secondary composition in the related art is merely to crop out the game photo which has been photographed again. The solution provided by the examples of this application is to change an orientation of the virtual object in the game scene, so that the content included in the game scene changes. Thus, the editing mode in the solution provided by the examples of this application is enriched, which can further meet the requirements of the user.
2. The freeze-frame time point of the new game photo is allowed to be selected within the time intervals earlier and later than the photographing time point of the game photo.

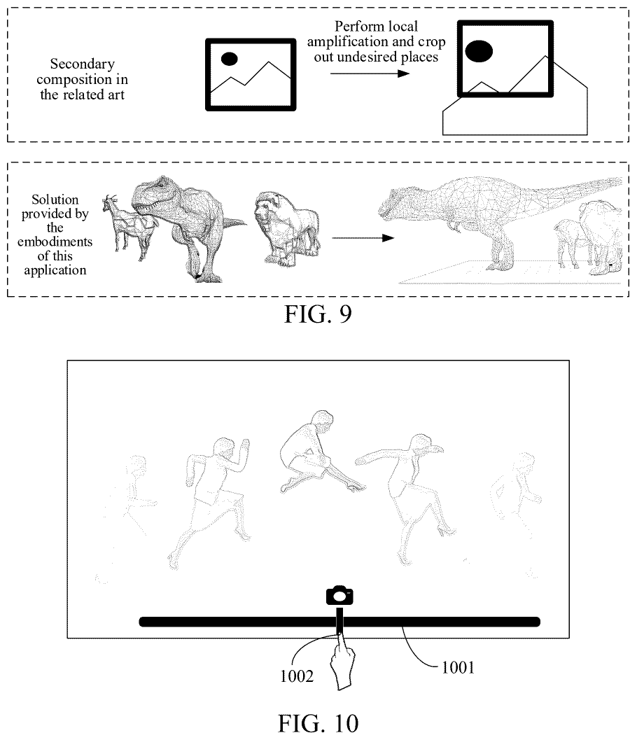

During game photo photographing, the game scene data within the time period including the photographing time point will be saved. In the game scene restored based on the game scene data, the scene progress bar is displayed. The time point included in the scene progress bar is the same as the time point within the time period. As shown in FIG. 10, taking the scene progress bar being a time slide rail 1001 as an example, within a plurality of time points corresponding to the time slide rail 1001, the virtual object in the game scene shows a continuous jumping action. The player drags a time caliper 1002 through the terminal to select the freeze-frame time point on the time slide rail. The time point corresponding to the position where the time caliper 1002 stops is the selected freeze-frame time point. The terminal displays a game scene at the selected freeze-frame time point, i.e., the player selects the freeze-frame time point by dragging the time caliper 1002, so that the action presented by the virtual object in the displayed game scene can satisfy the player. This image editing mode can reduce the probability of missing the optimal picture as the photographing button is not pressed timely or the photographing button is not pressed at a proper time. Even if the user misses the optimal picture, the user also can obtain the game photo including the optimal picture by adjusting the freeze-frame time point in the solution for delayed editing of editing the game photo, so that the user experience is improved.
3. The position of the virtual object in the game scene is allowed to be adjusted again.

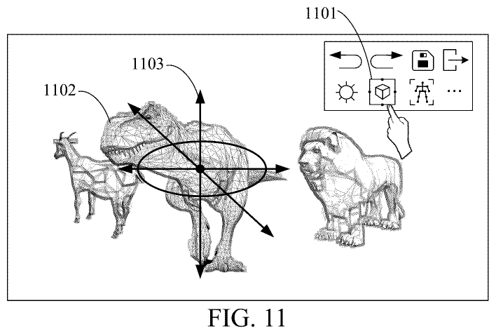

As shown in FIG. 11, the player clicks/taps the position adjusting option 1101 and then clicks/taps any virtual object 1102 in the game scene to display a position adjusting coordinate system 1103 to move and rotate the virtual object 1102, so as to adjust the position of the virtual object 1102 in the game scene. Alternatively, the virtual object 1102 can also be deleted, so that the virtual object 1102 is no longer displayed in the game scene. The content shielded by displaying the virtual object 1102 previously is displayed to enrich the content included in the game scene, so as to simulate an effect of photographing the picture in a real scene.
4. The posture of the virtual object in the game scene is allowed to be adjusted.

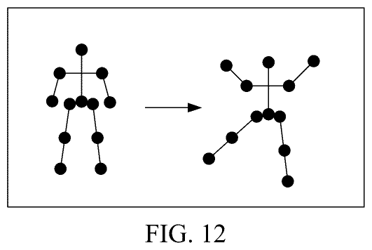

In the example of this application, the virtual object in the game scene is a movable virtual object. In a case that the terminal displays the restored game scene, as shown in FIG. 12, the player can adjust a skeleton state of the virtual object in the game scene through the terminal, so as to adjust the posture represented by the virtual object, so that the virtual object in the game scene is more vivid and better in sense of tableau, and therefore, the display effect of a subsequently generated new game photo is improved.

The example of this application is merely illustrated taking the above several adjustment modes as an example. In another embodiment, other adjustments of the restored game scene may also be made. For example, a light source of the game scene is adjusted. For example, a virtual sky box in the game scene is replaced, an illumination direction in the game scene is adjusted, or a facial expression of the virtual object is adjusted, or dressing of the virtual object is adjusted, and the like.

Based on the examples shown in FIG. 2 to FIG. 12, the example of this application further provides a flowchart of a method for editing a game scene image. The method includes a photographing stage and an editing stage.

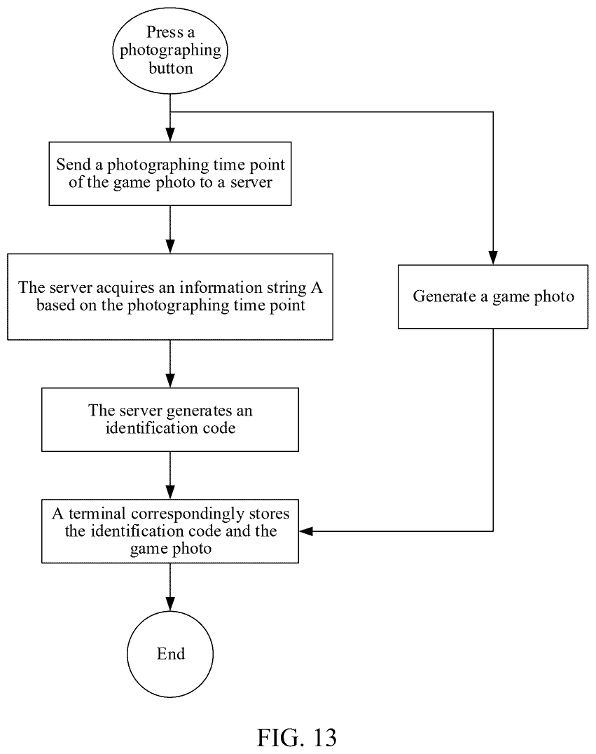

### As Shown in FIG. 13, the Photographing Stage Includes the Following Four Operations 1-4:

Operation 1. In the game ongoing process, when detecting that the player presses the photographing button, the terminal photographs the currently displayed game scene to obtain the game photo, and sends the photographing time point of the game photo to the server.

The terminal displays the photographing button in the game ongoing process, detecting that the player presses the photographing button, i.e., detecting the triggering operation for the photographing button is equivalent to receiving the photographing instruction.

Operation 2. The server determines the time period including the photographing time point based on the photographing time point. The camera position of the object identifier logged in by the terminal within the time period is determined, and the virtual object of the virtual camera within the photographing range of the camera position is determined. The game scene data is constituted by the object data of the virtual object within the time period, the game scene data being taken as an information string A.

In the example of this application, the server, upon receiving the photographing time point sent by the terminal, determines the time period including the photographing time point and acquires the position of the virtual camera within the time period, determines the virtual objects around the virtual camera, acquires the object data of the virtual object, and constitutes the game scene data by the object data. Since a map in the game has a latticed coordinate system, the position of the virtual camera can be represented by one coordinate value. The virtual objects around the virtual camera can be determined based on the coordinate values of the virtual camera and coordinate values of the virtual objects. The information string A is constituted by the coordinates of the virtual camera within the time period and the object data of the virtual objects around the virtual camera. That is, the information string A includes a plurality of time points within the time period and the coordinates of the virtual camera and the object data of the virtual objects around the virtual camera at each time point.

Operation 3. The server generates the identification code, correspondingly stores the identification code and the information string A, and sends the identification code to the terminal.

Operation 4. The terminal correspondingly stores the identification code and the game photo.

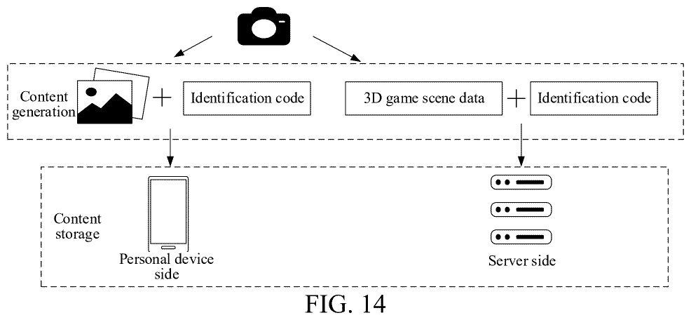

Based on the example shown in FIG. 13, taking the game being a 3D game as an example, the game scene data is 3D game scene data. In the photographing stage, as shown in FIG. 14, the terminal and the server respectively store different information. The terminal correspondingly stores the photos and the identification code, and the server correspondingly stores the identification code and the 3D game scene data. In the above photographing stage, after the player clicks/taps the photographing button through the terminal, the terminal generates the game photo and correspondingly stores the game photo and the identification code that is generated by the server. The server will further acquire the information string A of the game photo, and correspondingly stores the information string A and the identification code. The information string A serves as the game scene data of the game photo. The data volume of the information string A is large. Therefore, the server correspondingly stores the information string A and the identification code to alleviate the storage pressure of the terminal. According to the game photo saved in the operation included in the above photographing stage, the player can restore the game scene at any time, so that the game photo is re-edited.

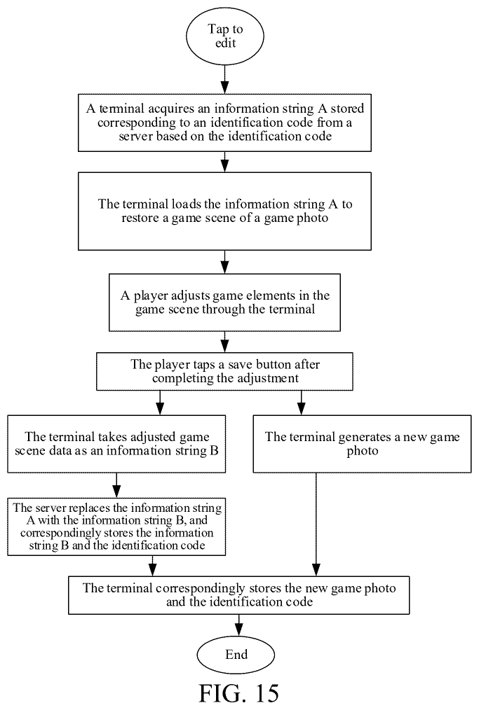

As shown in FIG. 15, the editing stage includes the following operations 1-5:

Operation 1. When detecting that the player performs the editing operation for any game photo at the end of the game, the terminal reads the identification code stored corresponding to the game photo, and acquires the information string A stored corresponding to the identification code from the server based on the identification code.

In a case that any game photo viewed is displayed, the terminal further displays the content editing button, and detecting that the player performs the editing operation for any game photo, i.e., detecting the operation of pressing the content editing button by the player is equivalent to receiving the editing instruction for the game photo. In the example of this application, after the player selects the game photo for edition, the terminal interacts with the server and acquires the information string A stored corresponding to the identification code from the server.

Operation 2. The terminal loads the information string A to restore the game scene of the game photo.

In the example of this application, the terminal, based on the data included in the received information string A, calls the included virtual object resources at the map position again for calculation and rendering to restore an operation supporting game scene again.

Operation 3. The player adjusts the game elements in the restored game scene through the terminal.

In the example of this application, after the game scene is restored, the player can adjust the virtual object in the game scene. The adjusting process is similar to the adjusting process shown in FIG. 8 to FIG. 12, which is not repeatedly described herein.

Operation 4. Upon adjusting the game scene, the player clicks/taps the save button displayed in the terminal, and the terminal generates the new game photo based on the adjusted game scene, replaces the original game photo with the new game photo, and correspondingly stores the new game photo and the identification code. Moreover, the terminal acquires the adjusted game scene data based on the adjusted game scene and sends an information string B which is the adjusted game scene data to the server.

Operation 5. The server replaces the information string A with the information string B, and correspondingly stores the information string B and the identification code.

In the example of this application, after the information string B is uploaded to the server, the server can cover the information string A with the information string B for re-writing, or the information string B serves as the latest information string which coexists with the information string A, a historical identifier is added for the information string A, and the latest information string B and the identification code are correspondingly stored.

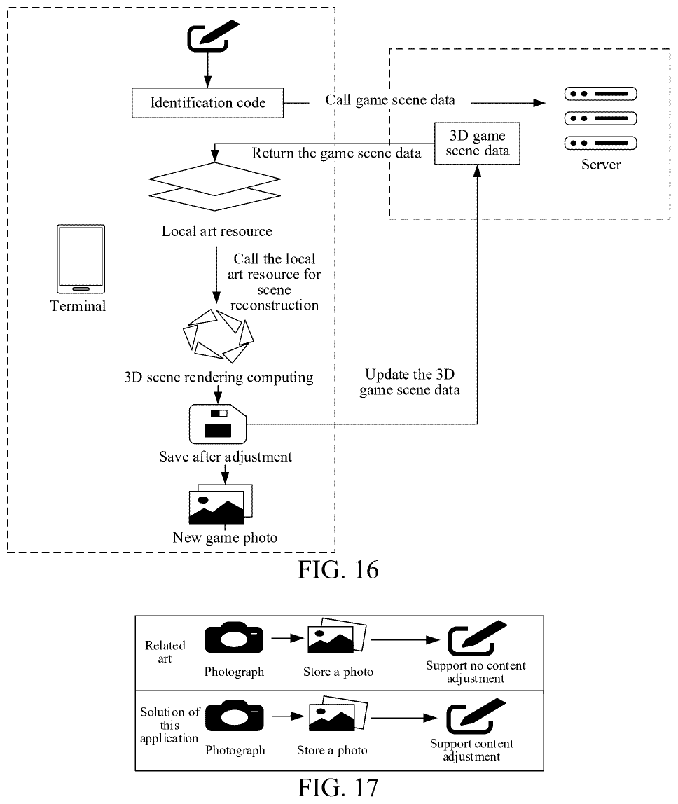

Based on the example shown in FIG. 15, taking the game being a 3D game as an example, the game scene data is 3D game scene data. In the editing stage, the interacting process between the terminal and the server is shown in FIG. 16. Upon acquiring the 3D game scene data of the game photo by interacting with the server, the terminal calls the local art resource for 3D scene rendering computing to restore the game scene of the game photo. When storing the adjusted game scene, the terminal generates the new game photo and interacts with the server, and the server updates the stored 3D game scene data.

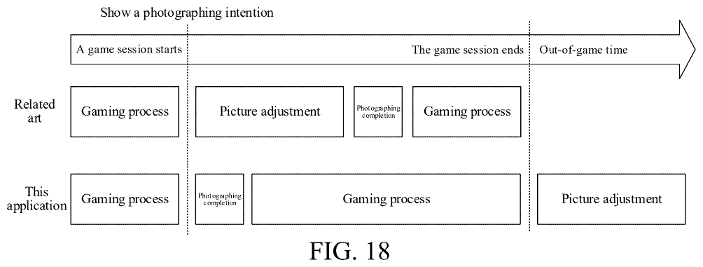

Based on the examples show in FIG. 2 to FIG. 16, the solution provided by the examples of this application is compared with an image editing solution in the related art. As shown in FIG. 17 and FIG. 18, upon generating the game scene image, the image editing solution in the related art does not support adjustment of the content of the game photo but the solution provided by the examples of this application supports adjustment of the content of the game photo. Moreover, in at least some the image editing solutions, when the game scene image is photographed, the picture of the game scene is adjusted during the process of the game session, which will affect normal proceeding of the game. As described herein, the photographing operation is executed in the game ongoing process, and at the end of the game session, the game scene corresponding to the game photo is then restored, and the picture of the game scene is adjusted to adjust the content of the game photo.

Based on the examples shown in FIG. 2 to FIG. 18, the examples of this application provide a solution in which the player is allowed to still edit the stored game photo even if the photo has been photographed and stored. Moreover, for the editing of the game photo, it is not a conventional adjustment of filter parameters of the generated game photo, but involve the adjustment of essential content in the generated game photo. That is, the content included in the game photo is adjusted by adjusting the content of the game scene of the game photo, which breaks the recognition on a conventional game photo editing mode, thereby providing more editing probabilities. In the example of this application, the player is supported to press the photographing button first to save the game photo to a storage path of the game in the real-time game and then edits the saved game photo at the end of the game. That is, the player is allowed to press the photographing button to record the current game scene and then performs accurate composition of the photographed photo and content adjustment of the game scene when there is sufficient time, so that the game photo not only records the game scene displayed when the photographing button is pressed, but also has a secondary creating function. This game scene image editing mode can avoid poor player experience due to inaccurate time invalidity of the photographed game photo, and moreover, in the game ongoing process, the player will not be distracted as the game photo is photographed to adjust the game scene, so that the player can further focus on experience of battle/playing method/game process themselves. That is, the player better focuses on experience of the game itself in the gaming process, so that the time consumed by tedious photographing settings is shortened. The experience of the game is guaranteed, and further the player experience is improved.

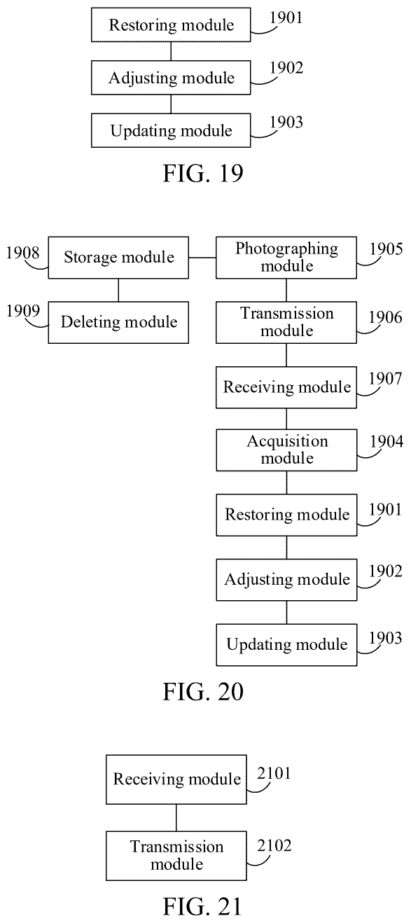

FIG. 19 is a schematic structural diagram of an apparatus for editing a game scene image provided by an example of this application. As shown in FIG. 19, the apparatus includes:
a restoring module 1901, configured to load, in response to an editing instruction for the game scene image, game scene data of the game scene image to restore a game scene of the game scene image, the game scene image being obtained by photographing the game scene in a game ongoing process;
an adjusting module 1902, configured to adjust, in response to an adjusting operation for game elements in the game scene, the game elements in the game scene and display an adjusted game scene; and
an updating module 1903, configured to update, in response to an image saving instruction, the game scene image based on the adjusted game scene.

In a possible implementation, the adjusting module 1902 is configured to execute at least one of the following:
in response to a focal length adjusting operation of a virtual camera in a game, adjusting a focal length of the virtual camera and displaying the game scene photographed by the virtual camera based on an adjusted focal length;
in response to the position adjusting operation of the virtual camera in the game, adjusting a position of the virtual camera and displaying the game scene photographed by the virtual camera at an adjusted position;
in response to a viewing angle adjusting operation for the virtual camera in the game, adjusting a photographing viewing angle of the virtual camera and displaying a game scene photographed by the virtual camera based on an adjusted photographing viewing angle;
in response to a position adjusting operation for a first virtual object in the game scene, adjusting a position of the first virtual object and display an adjusted game scene;
in response to a posture adjusting operation for a second virtual object in the game scene, adjusting a posture of the second virtual object and display an adjusted game scene; and
in a case that the scene progress bar of the game scene is displayed, in response to a time selection operation for the scene progress bar, determining a freeze-frame time point selected from the scene progress bar and displaying a game scene at the freeze-frame time point, the scene progress bar including a photographing time point of the game scene image and a time point earlier or later than the photographing time point.

In another possible implementation, the updating module 1903 is configured to photograph, in response to the image saving instruction, the adjusted game scene to obtain a new game scene image; and replace the game scene image with the new game scene image.

In another possible implementation, as shown in FIG. 20, the apparatus further includes:
an acquisition module 1904, configured to locally acquire, in response to the editing instruction for the game scene image, the game scene data stored corresponding to the game scene image; or
an acquisition module 1904, configured to send, in response to the editing instruction for the game scene image, a data acquisition request to a server, the data acquisition request carrying an identification code of the game scene image, the server being configured to query, based on the data acquisition request, the game scene data stored corresponding to the identification code and return the game scene data; and receive the game scene data returned by the server.

In another possible implementation, as shown in FIG. 20, the apparatus further includes:
a photographing module 1905, configured to photograph, in the game ongoing process, in response to a photographing instruction, a currently displayed game scene to obtain a game scene image;
a transmission module 1906, configured to send the photographing time point of the game scene image to the server, the server being configured to acquire the game scene data at the photographing time point, generate the identification code, correspondingly store the game scene data and the identification code, and return the identification code; and
a receiving module 1907, configured to receive the identification code returned by the server and correspondingly store the game scene image and the identification code.

In another possible implementation, as shown in FIG. 20, the apparatus further includes:
a photographing module 1905, configured to photograph, in the game ongoing process, in response to a photographing instruction, a currently displayed game scene to obtain a game scene image; and
a storage module 1908, configured to correspondingly store the game scene image and the game scene data.

In another possible implementation, as shown in FIG. 20, the apparatus further includes:
a deleting module 1909, configured to delete, from the end of the game, in a case that a duration reaches a target duration and the editing instruction for the game scene image is not received, the game scene data.

In another possible implementation, as shown in FIG. 20, the apparatus further includes:
a transmission module 1906, configured to, in response to the image saving instruction, acquire the adjusted game scene data based on the adjusted game scene and send the adjusted game scene data to the server, the server being configured to correspondingly store the adjusted game scene data and the identification code.

The apparatus for editing a game scene image provided in the above examples is illustrated by taking division of the above functional modules as an example. In practical application, functions may be completed by different functional modules. To be specific, an internal structure of a computer device is divided into different functional modules to complete all or some of the functions described above. In addition, the apparatus for editing a game scene image provided in the above examples and the method examples for editing a game scene image belong to the same concept. For details of a specific implementation process, reference may be made to the method examples, which is not repeatedly described herein.

FIG. 21 is a schematic structural diagram of an apparatus for editing a game scene image provided by an example of this application. As shown in FIG. 21, the apparatus includes:
a receiving module 2101, configured to receive a data acquisition request sent by a terminal, the data acquisition request carrying an identification code of the game scene image and the data acquisition request being sent by the terminal in response to an editing instruction for the game scene image; and
a transmission module 2102, configured to query game scene data stored corresponding to the identification code based on the data acquisition request and send the game scene data to the terminal,

The terminal is configured to receive the game scene data and load the game scene data to restore a game scene of the game scene image; in response to an adjusting operation for game elements in the game scene, adjust the game elements in the game scene and display an adjusted game scene; and in response to an image saving instruction, update the game scene image based on the adjusted game scene.

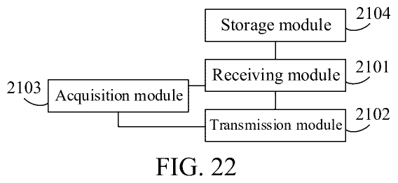

In another possible implementation, as shown in FIG. 22, the apparatus further includes:
a receiving module 2101, further configured to receive a photographing time point of the game scene image sent by the terminal, the photographing time point being a time point at which the game scene image is photographed by the terminal in the game ongoing process;
an acquisition module 2103, configured to acquire the game scene data at the photographing time point to generate the identification code; and
a transmission module 2102, further configured to correspondingly store the game scene data and the identification code, send the identification code to the terminal, and correspondingly store the game scene image and the identification code by the terminal.

In another possible implementation, the acquisition module 2103 is configured to determine the time period including the photographing time point based on the photographing time point; and acquire the game scene data within the time period.

In another possible implementation, the receiving module 2101 is configured to receive the photographing time point sent by the terminal and an object identifier logged in by the terminal; and

the acquisition module 2103 is configured to determine a camera position of the object identifier within the time period, the camera position being a position of a virtual camera in the game scene displayed by the terminal within the time period in the game ongoing process; determine a virtual object of the virtual camera within a photographing range of the camera position; and constitute the game scene data by object data of the virtual object within the time period.

In another possible implementation, as shown in FIG. 22, the apparatus further includes:
a receiving module 2101, further configured to receive adjusted game scene data sent by the terminal; and
a storage module 2104, configured to correspondingly store the adjusted game scene data and the identification code.

The apparatus for editing a game scene image provided in the above examples is illustrated by taking division of the above functional modules as an example. In practical application, functions may be completed by different functional modules. To be specific, an internal structure of a computer device is divided into different functional modules to complete all or some of the functions described above. In addition, the apparatus for editing a game scene image provided in the above examples and the method examples for editing a game scene image belong to the same concept. For details of a specific implementation process, reference may be made to the method examples, which is not repeatedly described herein.

An example of this application further provides a computer device. The computer device includes a processor and a memory, the memory having at least one computer program stored therein, the at least one computer program being loaded and executed by the processor to implement the operations of the methods for editing a game scene image in the above examples.

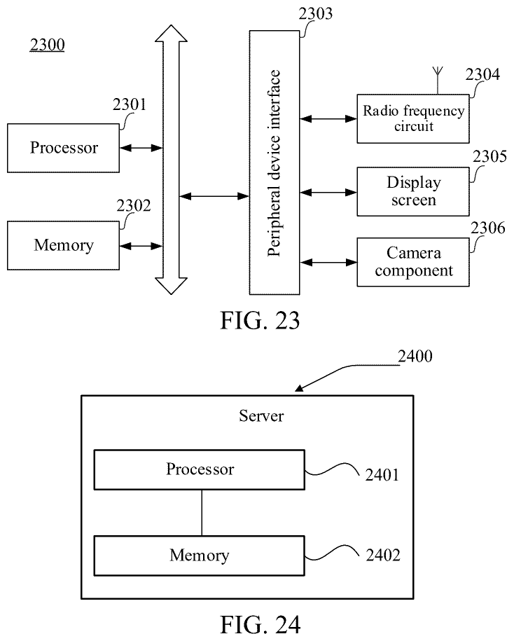

In one embodiment, the computer device is provided as a terminal. FIG. 23 is a schematic structural diagram of a terminal 2300 provided by an exemplary example of this application. The terminal 2300 includes a processor 2301 and a memory 2302.

The processor 2301 may include one or more processing cores, for example, a 4-core processor or an 8-core processor. The processor 2301 may be implemented in at least one hardware form of a digital signal processor (DSP), a field-programmable gate array (FPGA), and a programmable logic array (PLA). The processor 2301 may also include a main processor and a coprocessor. The main processor is configured to process data in an active state, also referred to as a central processing unit (CPU). The coprocessor is a low-power-consumption processor configured to process data in a standby state. In some examples, the processor 2301 may be integrated with a graphics processing unit (GPU). The GPU is configured to render and draw content that needs to be displayed on a display screen. In some examples, the processor 2301 may further include an artificial intelligence (AI) processor. The AI processor is configured to process computing operations related to machine learning.

The memory 2302 may include one or more computer-readable storage media. The computer-readable storage media may be non-transient. The memory 2302 may further include a high-speed random access memory and a nonvolatile memory, for example, one or more disk storage devices or flash storage devices. In some examples, the non-transient computer-readable storage media in the memory 2302 are configured to store at least one computer program. The at least one computer program is configured to be executed by the processor 2301, to implement the methods for editing a game scene image provided by the method examples of this application.

In some examples, the terminal 2300 may also include: a peripheral device interface 2303 and at least one peripheral device. The processor 2301, the memory 2302, and the peripheral device interface 2303 may be connected through a bus or a signal cable. Each peripheral device may be connected to the peripheral device interface 2303 through a bus, a signal cable, or a circuit board. Specifically, the peripheral device includes: at least one of a radio frequency circuit 2304, a display screen 2305, or a camera component 2306.

The peripheral device interface 2303 may be configured to connect the at least one peripheral device related to input/output (I/O) to the processor 2301 and the memory 2302. In some examples, the processor 2301, the memory 2302, and the peripheral device interface 2303 are integrated on a same chip or circuit board. In some other examples, any one or two of the processor 2301, the memory 2302, and the peripheral device interface 2303 may be implemented on an independent chip or circuit board, which is not limited in this embodiment.

The radio frequency circuit 2304 is configured to receive and transmit a radio frequency (RF) signal that is also referred to as an electromagnetic signal. The RF circuit 2304 communicates with a communication network and other communication devices through the electromagnetic signal. The RF circuit 2304 converts an electric signal into an electromagnetic signal for sending, or converts a received electromagnetic signal into an electric signal.

The display screen 2305 is configured to display a user interface (UI). The UI may include a graph, a text, an icon, a video, and any combination thereof. When the display screen 2305 is a touch display screen, the display screen 2305 is further capable of collecting touch signals on or above a surface of the display screen 2305. The touch signal may be inputted to the processor 2301 as a control signal for processing. In this case, the display screen 2305 may be further configured to provide a virtual button and/or a virtual keyboard that are/is also referred to as a soft button and/or a soft keyboard.

The camera component 2306 is configured to capture images or videos. In one embodiment, the camera component 2306 includes a front camera and a rear camera. The front camera is arranged on a front panel of the terminal, and the rear camera is arranged on a back of the terminal. In some examples, there are at least two rear cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions.

A person skilled in the art may understand that the structure shown in FIG. 23 constitutes no limitation on the terminal 2300, and the terminal may include more or fewer components than those shown in the figure, or some components may be combined, or a different component deployment may be used.

In one embodiment, the computer device is provided as a server. FIG. 24 is a schematic structural diagram of a server according to an example of this application. A server 2400 may vary considerably depending on configuration or performance, and may include one or more central processing units (CPUs) 2401 and one or more memories 2402. Each memory 2402 has at least one computer program stored therein. The at least one computer program is loaded and executed by the processor 2401, to implement the methods provided in the above method examples. Of course, the server may further have components such as a wired or wireless network interface, a keyboard, and an input/output interface for input and output. The server may further include another component for achieving a device function. Details are not described herein.

An example of this application further provides a computer-readable storage medium, having at least one computer program stored therein, the at least one computer program being loaded and executed by a processor, to implement the operations of the methods for editing a game scene image provided by the above examples.

An example of this application further provides a computer program product, including a computer program, the computer program, when executed by a processor, implementing the operations of the methods for editing a game scene image provided by the above examples.

A person of ordinary skill in the art may understand that all or some of the operations implementing the above examples may be implemented by hardware, or may be implemented by instructing relevant hardware through a program. The program may be stored in a computer-readable storage medium. The storage medium may be a read-only memory, a disk, an optical disc, or the like.

The above descriptions are merely exemplary examples of the examples of this application, and are not intended to limit the examples of this application. Any modification, equivalent replacement, improvement, or the like made within the spirit and principle of the examples of this application falls within the protection scope of this application.

What is claimed is:

1. A method comprising:
receiving, by a terminal, an editing instruction for editing a game scene image;
obtaining, in response to the editing instruction, game scene data of the game scene image;
receiving an adjusting operation for adjusting game elements in the game scene image;
adjusting, in response to the adjusting operation, the game elements;
displaying, on a user interface associated with the terminal, an adjusted game scene; and
generating, in response to an image saving instruction, an updated game scene image of the adjusted game scene.

2. The method according to claim 1, wherein the adjusting the game elements comprises at least one of:
adjusting, in response to a focal length adjusting operation for a virtual camera in a game, a focal length of the virtual camera;
adjusting, in response to a position adjusting operation for the virtual camera, a position of the virtual camera;
adjusting, in response to a viewing angle adjusting operation for the virtual camera, a photographing viewing angle of the virtual camera;
adjusting, in response to a position adjusting operation for a first virtual object in the game scene, a position of the first virtual object; or
adjusting, in response to a posture adjusting operation for a second virtual object in the game scene, a posture of the second virtual object.

3. The method according to claim 1, further comprising:
receiving a time selection operation for a scene progress bar displayed in the game scene, wherein the time selection operation indicates a freeze-frame time of a game associated with the game scene, wherein the freeze-frame time is different from a time point when the game scene image is photographed; and
generating a new game scene image corresponding to the freeze-frame time of the game.

4. The method according to claim 1, wherein the generating the updated game scene image comprises:
photographing, in response to the image saving instruction, the adjusted game scene; and
replacing the game scene image with the updated game scene image.

5. The method according to claim 1, wherein the obtaining the game scene data of the game scene image comprises:
acquiring the game scene data stored locally; or
receiving, from a server configured to query the game scene data stored corresponding to an identification code, the game scene data.

6. The method according to claim 1, further comprising:
photographing, during an ongoing game process, a currently displayed game scene to obtain the game scene image; and
storing the game scene data of the game scene image.

7. The method according to claim 1, further comprising:
deleting, at the end of the game and based on a determination that a duration reaches a target duration and the editing instruction for the game scene image is not received, the game scene data.

8. The method according to claim 1, wherein the obtaining the game scene data comprises:
photographing, during an ongoing game process, a currently displayed game scene to obtain the game scene image;
transmitting, to a server, the game scene image and a timestamp indicating a time when the game scene image is photographed; and
receiving, from the server, an identification code for identifying the game scene image.

9. The method according to claim 1, further comprising:
sending, to a server, the adjusted game scene data.

10. A method comprising:
receiving, by a server from a terminal, a data acquisition request, carrying an identification code of a game scene image, wherein the data acquisition request is transmitted in response to an editing instruction for the game scene image;
querying, based on the data acquisition request, game scene data stored corresponding to the identification code; and
transmitting, to the terminal, the game scene data for adjusting the game elements in the game scene and displaying an adjusted game scene.

11. The method according to claim 10, further comprising, prior to the receiving the data acquisition request:
receiving, from the terminal, a photographing time point of the game scene image, wherein the photographing time point is a time point at which the game scene image is photographed by the terminal in a game ongoing process;
acquiring game scene data at the photographing time point;
generating the identification code;
storing the game scene data and the identification code;
transmitting the identification code to the terminal.

12. The method according to claim 11, wherein the acquiring game scene data at the photographing time point comprises:
determining a time period comprising the photographing time point; and
acquiring game scene data within the time period.

13. The method according to claim 12, further comprising:
receiving, from the terminal, an object identifier indicating a virtual camera associated with the game scene image.

14. The method according to claim 13, wherein the acquiring game scene data within the time period comprises:
determining a camera position within the time period, the camera position being a position of the virtual camera in the game scene displayed by the terminal within the time period in the game ongoing process;
determining a virtual object of the virtual camera within a photographing range of the camera position; and
constituting the game scene data by using object data of the virtual object within the time period.

15. The method according to claim 10, further comprising, after the transmitting the game scene data:
receiving, from the terminal, adjusted game scene data; and
storing the adjusted game scene data and the identification code.

16. A terminal comprising:
one or more processors; and
memory storing instructions, when executed by the one or more processors, cause the terminal to perform actions comprising:
receiving an editing instruction associated with a game scene image;
obtaining, in response to the editing instruction, game scene data of the game scene image;
receiving an adjusting operation for adjusting game elements in the game scene image;
adjusting, in response to the adjusting operation, the game elements;
displaying, on a user interface associated with the terminal, an adjusted game scene; and
generating, in response to an image saving instruction, an updated game scene image associated with the adjusted game scene.

17. The terminal according to claim 16, wherein the instructions, when executed by the one or more processors, cause the terminal to adjust the game elements by performing at least one of:
adjusting, in response to a focal length adjusting operation for a virtual camera in a game, a focal length of the virtual camera;
adjusting, in response to a position adjusting operation for the virtual camera, a position of the virtual camera;
adjusting, in response to a viewing angle adjusting operation for the virtual camera, a photographing viewing angle of the virtual camera;
adjusting, in response to a position adjusting operation for a first virtual object in the game scene, a position of the first virtual object; or
adjusting, in response to a posture adjusting operation for a second virtual object in the game scene, a posture of the second virtual object.

18. The terminal according to claim 16, wherein the instructions, when executed by the one or more processors, cause the terminal to further perform actions comprising:
receiving a time selection operation for a scene progress bar displayed in the game scene, wherein the time selection operation indicates a freeze-frame time of a game associated with the game scene, wherein the freeze-frame time is different from a time point when the game scene image is photographed; and
generating a new game scene image corresponding to the freeze-frame time of the game.

19. The terminal according to claim 16, wherein the instructions, when executed by the one or more processors, cause the terminal to generate the updated game scene image by performing actions comprising:
photographing, in response to the image saving instruction, the adjusted game scene; and
replacing the game scene image with the updated game scene image.

20. The terminal according to claim 16, wherein the instructions, when executed by the one or more processors, cause the terminal to obtain the game scene data by performing actions comprising:
acquiring the game scene data stored locally; or
receiving, from a server configured to query the game scene data stored corresponding to an identification code, the game scene data.
